(19) United States
(12) Patent Application Publication
(10) Pub. No.: US 2023/0364486 A1
(43) Pub. Date: Nov. 16, 2023

(54) Scorecard Device

(71) Applicant: Bruce Denis, Niagara Falls (CA)

(72) Inventor: Bruce Denis, Niagara Falls (CA)

(21) Appl. No.: 17/743,597

(22) Filed: May 13, 2022

(51) Int. Cl. A63B 71/06

(52) U.S. Cl. CPC A63B 71/06; A63B 2071/0602; A63B 2102/32

(57) ABSTRACT

The present invention relates generally to the field of scoring cards. More specifically, the present invention relates to a scorecard device comprised of a body further comprised of at least one etchable surface portion and a non-etchable surface portion. The etchable surface portion can be etched using a golf tee, fingernail, or other apparatus to allow a user to mark the device with a score or other sport or activity related markings. One embodiment of the device may be comprised of at least one crease that allows the device to fold. The device further includes a method of manufacturing the scorecard device.

### CROSS-REFERENCE TO RELATED APPLICATION

The present application claims priority to, and the benefit of, U.S. Provisional Application No. 63/118,047, which was filed on May 13, 2021, and is incorporated herein by reference in its entirety.

### FIELD OF THE INVENTION

The present invention relates generally to the field of scoring cards. More specifically, the present invention relates to a scorecard device comprised of a body further comprised of at least one etchable surface portion and a non-etchable surface portion. The etchable surface portion can be etched using a golf tee, fingernail, or other apparatus to allow a user to mark the device with a score or other sport or activity related markings. One embodiment of the device may be comprised of at least one crease that allows the device to fold. The device further includes a method of manufacturing the scorecard device. Accordingly, the present disclosure makes specific reference thereto. Nonetheless, it is to be appreciated that aspects of the present invention are also equally applicable to other like applications, devices and methods of manufacture.

### BACKGROUND

Tracking performance information is an integral part of many competitive activities, including sports. Traditionally, writing utensils like pencils, pens, ink markers, or chalk have been used to keep track of scoring information in conjunction with a writing surface, like a piece of paper or a chalkboard. Many sporting venues have moved away from physical means of recording scores and, instead, use electronic lighting displays to track and easily communicate information relevant to a game's rules, win conditions, player performance statistics, or other useful or interesting details. With the rise in popularity of mobile electronic devices, electronic means of recording scoring information is also available to participants in, or attendees to, a competitive event.

However, reliance on writing utensils or an electronic means of recording performance information is accompanied by several limitations. First, writing utensils like pencils, pens, ink markers, or chalk may become separated from a corresponding recording document, rendering players or observers of a competitive activity unable to track relevant information and determine winners or other performance metrics. Writing utensils also have a finite writing capacity based on graphite or ink content or the size of a piece of chalk. The graphite of a pencil may also break, ink from pens or markers may smear or smudge, and chalk may shatter. These failures are especially problematic as failure of the writing device renders both the utensil and the recording document of no use to persons wishing to record sporting information. Furthermore, many writing utensils can be messy and inadvertently deposit graphite, ink, or chalk residue on a user, a user's clothes, or a user's sporting equipment. Provided the esteem carried by, and expense invested in, sporting apparel and equipment, staining or other inadvertent aesthetic marking thereof is greatly undesirable.

Persons wishing to record competitive performance information may alternatively contemplate the use of a mobile electronic device, like a smartphone or tablet. In addition to the risk of cheating arising from modifying scores or performance information during a competitive activity, the use of an electronic device to record data invariably requires a power supply. If a mobile device lacks an energy reserve sufficient to meet both a user's normal daily usage demands and the energy demands from recording sporting information during play, scoring details may be lost during a game without clear determination of a winner. Mobile devices also do not inherently provide a user interface suitable for recording performance information for a specific sport, like golf Instead, mobile device users must construct their own scoring records using ill-suited, general note-taking software or find a third-party app at an additional cost or with in-app ad functionality. Furthermore, removing the need for a physical writing apparatus can help curtail the spread of disease-causing contaminants, like COVID-19, or other viral, bacterial, fungal, protozoan, microbial, particulate, and xenobiotic contaminants.

Therefore, there exists a long-felt need in the art for a scorecard device. Further, there exists a long-felt need in the art for a scorecard device that allows a user to record performance information without the use of a writing apparatus. There also exists a long-felt need in the art for a scorecard device that permit users to make use of apparatuses readily available during an activity to record performance information on the device. In addition, there exists a long-felt need in the art for a scorecard device that eliminates the need for persons to physically pass a writing utensil between participants or attendees.

The subject matter disclosed and claimed herein, in one embodiment thereof, comprises a scorecard device. The device is comprised of a body further comprised of at least one etchable surface portion and a non-etchable surface portion. The etchable surface portion can be etched using a golf tee, fingernail, or other apparatus to allow a user to mark the device with a score or other sport or activity related markings. One embodiment of the device may be comprised of at least one crease that allows the device to fold. The device further includes a method of manufacturing the scorecard device.

In this manner, the scorecard device of the present invention accomplishes all of the foregoing objectives and provides a device that allows a user to record performance information without the use of a writing apparatus. The device also eliminates the need for persons to physically pass a writing utensil between participants or attendees. Further, the device permits users to make use of apparatuses readily available during an activity to record performance information on the device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a scorecard device. The device preferably has a planar body with an etchable surface portion, wherein the etchable surface portion is a thin film adhered to the approximately planar body, and wherein the thin film is comprised of a hardened mixture of an ink and a latex base. Similarly, the device may include a method of manufacturing such a performance recording document by mixing ink with a latex base, applying such a mixture to a portion of the approximately planar body, and hardening such a mixture using ultraviolet radiation to comprise the etchable thin film. Application of the ink and latex mixture may be accomplished using a spray-on machine or a screen-printing process.

In embodiments of the device, there may be multiple etchable surface portions which may be arranged to correspond to a scoring system for an activity. The ratio of ink to latex may be adjusted among embodiments of the invention, with a ratio of two parts ink per one part latex base being a preferred embodiment. The approximately planar body may be comprised of a rigid material, feature at least one foldable crease, or may be comprised of paper, plastic, metal, organic or synthetic materials, or any combination thereof. A hydrophobic film may coat the approximately planar body to confer water resistance or waterproofing. The approximately planar body may be a scorecard, and embodiments of the present invention may be adapted to create etchable surface portions on pre-existing scorecards.

Accordingly, the scorecard device of the present invention is particularly advantageous as it eliminates the need for a dedicated writing apparatus for recording performance information and allows participants or attendees to worry less about managing items in their possession while circumventing the problems otherwise commonly associated with pencils, pens, ink markers, chalk, or electronic means of recording information. Further, the device eliminates the need for an electronic scorekeeping device. In this manner, the scorecard device overcomes the limitations of existing scorekeeping devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a scorecard device of the present invention in accordance with the disclosed architecture;

FIG. 2 illustrates a top view of one potential embodiment of a scorecard device of the present invention in accordance with the disclosed architecture; and

FIG. 3 illustrates a flow chart of one potential method of making one potential embodiment of a scorecard device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a scorecard device. Further, there exists a long-felt need in the art for a scorecard device that allows a user to record performance information without the use of a writing apparatus. There also exists a long-felt need in the art for a scorecard device that permits users to make use of apparatuses readily available during an activity to record performance information on the device. In addition, there exists a long-felt need in the art for a scorecard device that eliminates the need for persons to physically pass a writing utensil between participants or attendees.

The present invention, in one exemplary embodiment, is comprised of a scorecard device comprised of a body. The body is further comprised of at least one etchable surface portion and a non-etchable surface portion, wherein the etchable surface portion can be etched using a golf tee, fingernail, or other apparatus to allow a user to mark the device with a score or other sport or activity related markings. One embodiment of the device may be comprised of at least one crease that allows the device to fold. The device further includes a method of manufacturing the scorecard device.

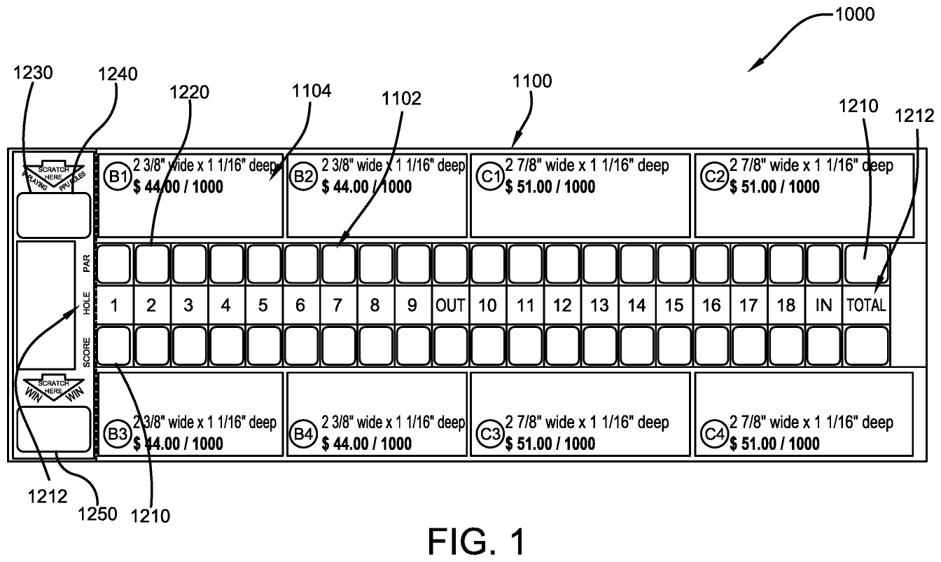

Referring initially to the drawings, FIG. 1 illustrates a perspective view of one potential embodiment of a scorecard device 1000 of the present invention in accordance with the disclosed architecture. The device may be comprised of a non-etchable body 1100 that is comprised of at least one etchable surface portion 1102. Differing etchable surface portions 1102 of the body 11000 may be used for (but is not limited to) recording player scores 1210, recording circumstantial scoring information 1220, indicating whether a user is participating in an activity 1230, indicating the rules applicable to an activity 1240, indicating whether a user is the winner of an activity 1250, etc. The non-etchable body 1100 may be comprised of at least one printed indicia 1212 wherein the indicia 1212 may be located on any portion 1102 of the body 1100. The indicia 1212 is preferably related to the rules of an activity, game, etc., or may help a user understand how to populate the etchable surface portions 1102 of the device 1000. Particularly, the indicia 1212 may be used to help designate whether an etchable surface portion 1102 is an etchable surface portion for recording player scores 1210, an etchable surface portion for recording circumstantial scoring information 1220, an etchable surface portion for indicating whether a user is participating in an activity 1230, an etchable surface portion for indicating the rules applicable to an activity 1240, or an etchable surface portion for indicating whether a user is the winner of an activity 1250.

According to an embodiment, a plurality of etchable surface areas 1102 on the body 1100 may permit users to record a plurality of different types of performance information. According to embodiments directed for use in (but not limited to) a sport such as golf, there may be etchable surface portions 1102 distinguished by size, shape, color, and/or indicia 1212 that are specifically designed for, but are not limited to, recording a user's score at a particular hole, the par values assigned to a hole, or for providing space for entry of general commentary. In the lattermost case, such etchable surface portions 1102 may not only permit recordation of performance information, but also promote the general social participation in and enjoyment of an activity. This may include, but is not limited to, having etchable surface portions 1102 that may receive comments on a competitor's performance, compliments, cheers, jeers, or other enjoyable input. According to a further embodiment, the variety of etchable surface areas 1102 may have a common unifying theme, such that the device 1000 is specifically suitable for a target demographic. Such demographics may include suitability for children, wherein participants or observers can include supportive feedback, or in competitive golfing tournaments, wherein participants can make strategic notes pertaining to player performance.

According to an embodiment, existing golf course scorecards may have a thin, film-like coating applied to create an etchable surface portion upon the scorecard. Such an etchable surface portion may be created from surface portions otherwise designated or intended for recording performance information using a pencil, pen, ink marker, or chalk. In this regard, embodiments of the device 1000 may be adapted for use with pre-existing scorecard layouts such that an etchable surface 1102 is created based on the formatting of the pre-existing scorecard for any sport. Consequently, embodiments of the invention may involve either the creation of a custom body 1100 with an etchable surface 1102 or the modification (using a method 3000) of existing sporting scorecards to have an etchable surface or surface portion 1102 that thereby eliminates the need for a separate writing apparatus. Instead, a user can simply use a golf tee, their own fingernails, or other similar object to mark the etchable surface 1102 as needed.

According to a further embodiment, the etchable surface 1102 may cover only a portion of the body 1100 such that there is a defined etchable surface portion 1102 and non-etchable surface portion 1104 of the body 1100. In this regard, the etchable surface portion 1102 may be used to record performance information while the non-etchable surface portion 1104 contains other information or indicia 1212 relevant to an activity such as, but not limited to, rules, instructions, or directions that guide a user participating in an activity or which explain how to populate the etchable surface portion 1102. According to an embodiment, the etchable surface portion 1102 and non-etchable surface portion 1104 may be arranged to resemble, mimic, or otherwise correspond to the rules or performance tracking needs of an activity.

The etchable surface portion 1102 may be partitioned by the non-etchable surface portion 1104 to provide a plurality of etchable surfaces arranged to resemble, mimic, or otherwise correspond to the rules or performance tracking needs of an activity. For example, the plurality of etchable surfaces 1102 may be arranged on the body of a recording document to illustrate how many rounds there are in a sporting activity, with each round of the sport being defined by a separate etchable space 1102 within which a score or other performance information for that round may be recorded.

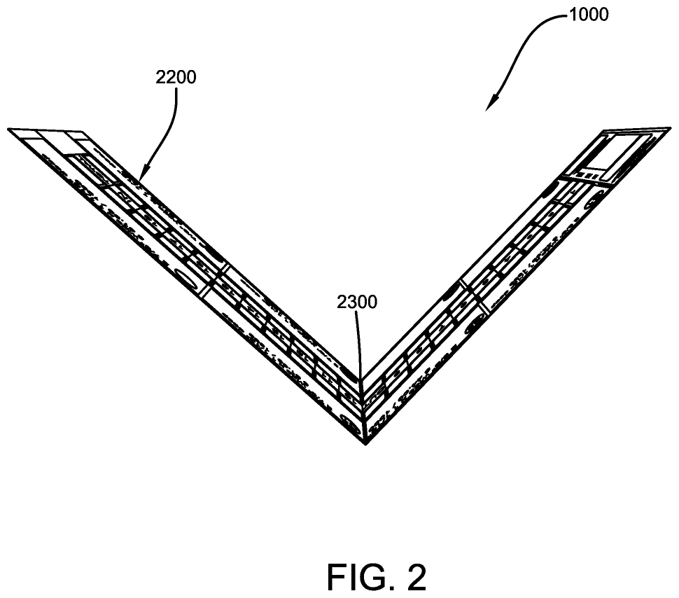

According to an embodiment shown in FIG. 2, one embodiment of the device 1000 may have a rigid non-etchable body 2200 with at least one foldable crease 2300 that is preferably and approximately centered in the rigid non-etchable body 2200. The rigid non-etchable body 2200 may be folded about the foldable crease 2300 to permit convenient storage of the device 1000 or to permit the performance recording document 1000 to stand on an edge, like as shown in FIG. 2. Folding the device 1000 may also be done to sequester the plurality of etchable surface portions 1102 within a fold, such that they are at least partially shielded from environmental conditions, like dust or moisture. It is appreciated that said embodiment may have all features of the previously described embodiment, in addition to the crease 2300.

In either embodiment, the etchable surface portion 1102 is treated to provide water resistance or waterproofing to minimize the risk of inadvertent damage to the etchable surface portion 1102 and, consequently, the risk of etched information smudging, smearing, or otherwise becoming illegible or lost. The device 1000 may be made from any combination of a paper, plastic, metal, organic, or synthetic material wherein the body 1100 may be treated with a hydrophobic film to achieve water resistance or waterproofing.

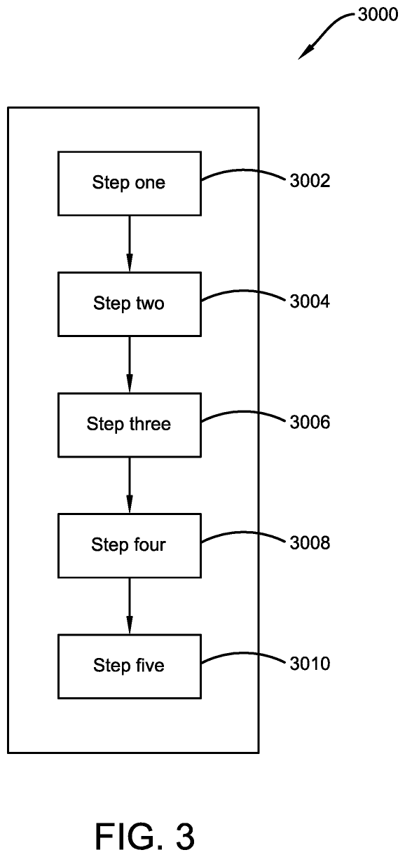

FIG. 3 illustrates a flow chart of one potential method 3000 of making one potential embodiment of a scorecard device 1000 of the present invention in accordance with the disclosed architecture. The device 1000 may also include a method for manufacturing a scorecard device with an etchable surface portion 3000. The method 300 first involves mixing paints together [Step 3002]. Next, a spray-on machine is used to apply the paint mixture to cover pre-designated areas of the body 1100 of the device 1000 [Step 3004]. According to a further embodiment, the paints may be a combination of colored paint and latex paint, and only a thin layer of the paint mixture may be applied. According to an embodiment, once the paint mixture is applied to the body 1100, the body 1100 is baked under an electromagnetic radiation source to enhance, bond, and harden the designated areas that are covered with the paint mixture [Step 3006]. According to a further embodiment, the electromagnetic radiation source is a UV lamp that uses UV light to enhance, bond, and harden the painted areas.

The etchable surface portion 1102 further has a rubberized ink coating that is preferably applied using a screen-printing process, wherein the rubberized ink coating is preferably comprised of a colored ink mixed with a clear latex base that is heated to ensure adhesiveness to the non-etchable body [Step 3008]. The colored ink may be grey or any other suitable coloration capable of creating visible contrast between an etchable surface portion 1102 and an etching upon the surface portion 1102. The etchable surface portion 1102 may also be comprised of silver paint and latex paint. The surface portion 1102 may be hardened using electromagnetic radiation from an electromagnetic radiation source, like ultraviolet (UV) light from a UV lamp [Step 3010]. In one embodiment, the etchable surface portion 1102 may be comprised of two parts silver paint per one part latex. Among such embodiments, the paint and latex film may confer water resistance or waterproof to the etchable surface portion of the recording document. It should be appreciated that all steps 3002, 3004, 3006, 3008, 3010 of the method 3000 may occur in any order, including simultaneously.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “scorecard device” and “device” are interchangeable and refer to the scorecard device 1000 of the present invention.

Notwithstanding the foregoing, the scorecard device 1000 of the present invention and its various components can be of any suitable size and configuration as is known in the art without affecting the overall concept of the invention, provided that they accomplish the above-stated objectives. One of ordinary skill in the art will appreciate that the size, configuration and material of the scorecard device 1000 as shown in the FIGS. are for illustrative purposes only, and that many other sizes and shapes of the scorecard device 1000 are well within the scope of the present disclosure. Although the dimensions of the scorecard device 1000 are important design parameters for user convenience, the scorecard device 1000 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A scorecard device comprising:
a planar body with an etchable surface portion, wherein the etchable surface portion is a film adhered to the planar body.

2. The scorecard device of claim 1, wherein the etchable surface portion is arranged to resemble, mimic, or otherwise correspond to a scoring system of an activity.

3. The scorecard device of claim 1, wherein the etchable surface portion does not cover the entirety of the planar body.

4. The scorecard device of claim 2, wherein the activity if golf.

5. The scorecard device of claim 1, wherein the film adhered to the planar body can be etched.

6. The scorecard device of claim 5, wherein the film is comprised of a hardened mixture of an ink and a latex base.

7. The scorecard device of claim 6, wherein the hardened mixture contains two parts of the ink per one part of the latex base.

8. The performance information recording document of claim 5, wherein the film is a hydrophobic film.

9. The scorecard device of claim 1, wherein the planar body is comprised of a rigid material.

10. The scorecard device of claim 1, wherein the planar body is comprised of a paper, a plastic, a metal, an organic or a synthetic material.

11. A scorecard device comprising:
a planar body further comprised of:
an etchable surface portion, wherein the etchable surface portion is a film adhered to the planar body;
a non-etchable surface portion; and
an indicia.

12. The scorecard device of claim 11, wherein the planar body is comprised of a foldable crease.

13. The scorecard device of claim 11, wherein the indicia designates the etchable surface portion.

14. The scorecard device of claim 13, wherein designation relates to recording player scores, recording circumstantial scoring information, indicating whether a user is participating in an activity, indicating the rules applicable to an activity, or indicating whether a user is the winner of an activity.

15. The scorecard device of claim 11, wherein the planar body is made from a paper, a plastic, a metal, an organic, or a synthetic material.

16. A method of manufacturing a scorecard device comprising the steps of:
mixing a paint mixture;
applying the paint mixture to a body of the scorecard device;
baking the body under an electromagnetic radiation source to harden the paint mixture;
applying a rubberized ink coating to an etchable surface portion via a screen printing process; and
baking the body under an electromagnetic radiation source to harden the rubberized ink coating.

17. The scorecard device of claim 16, wherein the rubberized ink coating is comprised of a colored ink mixed with a clear latex base.

18. The scorecard device of claim 16, wherein the etchable surface portion is alternatively covered with a paint.

19. The scorecard device of claim 18, wherein the paint is made from two parts silver and one part latex.

20. The scorecard device of claim 19, wherein the paint confers water resistance or waterproofing to the scorecard device.
